(19) United States
(12) Patent Application Publication
(10) Pub. No.: US 2014/0109970 A1
(43) Pub. Date: Apr. 24, 2014

(54) METAL CONE PLUG VALVE

(71) Applicant: PGI INTERNATIONAL, LTD., Houston, TX (US)

(72) Inventor: Peter Mark Middleton, Houston, TX (US)

(73) Assignee: PGI INTERNATIONAL, LTD., Houston, TX (US)

(21) Appl. No.: 13/659,625

(22) Filed: Oct. 24, 2012

(51) Int. Cl. F16K 5/00

(52) U.S. Cl. 137/1; 251/310

(57) ABSTRACT

The cone plug valve includes a valve body, a fluid inlet and a fluid outlet, a valve stem, and a cone supported on the valve stem. The metal cone is rotatably separate from the valve stem but moves axially in response to axially movement of the valve stem. A seat is fixably positioned within the valve body for sealing engagement with the cone, which has a sealing surface extending outward from the cone shaped exterior surface for sealing with the seat to close off flow through the valve body.

### FIELD OF THE INVENTION

The present invention relates to valves and, more particularly, to cone type plug valves. A seal between the cone or plug and the seat is formed as a result of a raised sealing face on the cone. The cone travels vertically with the stem while rotation of the cone is prohibited.

### BACKGROUND OF THE INVENTION

Plug valves are a common type of valve used in various industries. Plug valves conventionally utilize a sealing face on a seat to seal against a plug. The seat may be milled, molded or investment cast onto an insert. The insert with the cone is then forced down onto the insert and a seal is made between the face of the cone and the raised seat area on the insert.

U.S. Pat. No. 7,965,788 discloses a technique to align a seat ring in a valve. U.S. Pat. No. 5,615,708 discloses a control valve with a non-plugging valve trim. A valve having a convex sealing surface and a concave seating surface is disclosed in U.S. Pat. No. 5,226,445. Various types of plug valves are also disclosed in U.S. Pat. No. 5,044,604 and U.S. Pat. No. 4,614,330.

The technique of sealing between a plug and a raised seat on an insert becomes difficult to manufacture as the size of the orifice in the seat is reduced. Moreover, this difficulty is exasperating when trying to form a high temperature metal-to-metal seal, since the sealing forces are high and the finish on the sealing surfaces is critical. The configuration and small size of the parts results in the proper machining being be difficult, time consuming and expensive.

The disadvantages of the prior art are overcome by the present invention, an improved remotely operated shutoff valve is hereinafter disclosed.

### SUMMARY OF THE INVENTION

In one embodiment, the metal cone plug valve comprises of valve body, a valve stem axially relative to the valve body, and a cone supported on the valve stem and having a generally cone shaped exterior surface. The cone is rotatably separate from the valve stem and is axially movable in response to the axially movement of the valve stem. A seat fixably positioned within the valve body is provided for sealing engagement with the metal cone. The metal cone includes a seating surface extending outward from the cone shaped exterior surface for sealing with the seat to close off flow through the through passageway in the valve body.

These and further features and advantages of the present invention will become apparent from the following detailed description, wherein reference is made to the figures in the accompanying drawings.

### BRIEF DESCRIPTION OF THE DRAWINGS

FIG. 1 is an isometric view of a suitable cone according to the present invention.

FIG. 2 is a side view of the cone shown in FIG. 1.

FIG. 3 is a side view of a valve including the cone as shown in FIGS. 1 and 2.

FIG. 4 is a cross-sectional view of the valve shown in FIG. 3.

FIG. 5 is a side view of a valve according to the present invention.

FIG. 6 is an end view of the valve shown in FIG. 5.

FIG. 7 is an isometric view of another embodiment of suitable cone.

FIG. 8 is a side view of the cone shown in FIG. 7.

FIG. 9 is an isometric view of a base plate and legs which fit within the cone shown in FIG. 7.

FIG. 10 is a side view of a base plate and legs shown in FIG. 8.

### DETAILED DESCRIPTION OF PREFERRED EMBODIMENTS

The present invention effectively removes the raised sealing surface on the seat fixed to the valve body of a plug valve, and provides that sealing surface on the cone, thereby obtaining the needed pounds per square inch to reliably seal between the seat and the cone. The sealing surface on the cone may be removed completely from the assembly, resulting in the reduction of parts and simplification of the machining process. The modified cone fits within an established seat configuration and no machining of the seat is necessary for reliable sealing and thus valve shut off. The desired finish of the inside of the valve pocket may be maintained to a sufficiently high standard so that the generally conical plug will reliably seal. If the sealing surface in the cone becomes damaged due to nicks or machining marks, there is the ability to lap the sealing face on the cone to form a reliable sealed surface on the cone. By moving the sealing face to the cone, the stresses needed to maintain a seal at elevated temperatures are reduced. The present design also allows a valve configuration that will seal and operate in high temperature environments and is intrinsically fire safe. An investment casting may be used followed by a simple machining operation to face off the seat.

The cone is actuated into the seat by a stem that travels vertically (axially) within the confines of the valve bonnet. The stem to cone connection may be of a dovetail design or other design that allows the stem to turn without causing rotation of the cone. The cone orientation may be maintained by the use of an alignment pin pressed into the body of the valve which allows the cone to slide vertically (axially) while maintaining perpendicularity of the seat face on the cone to the bore. The seat face or seat sealing surface is thus aligned generally perpendicular to the throughbore in the valve body in order to maintain a reliable seal.

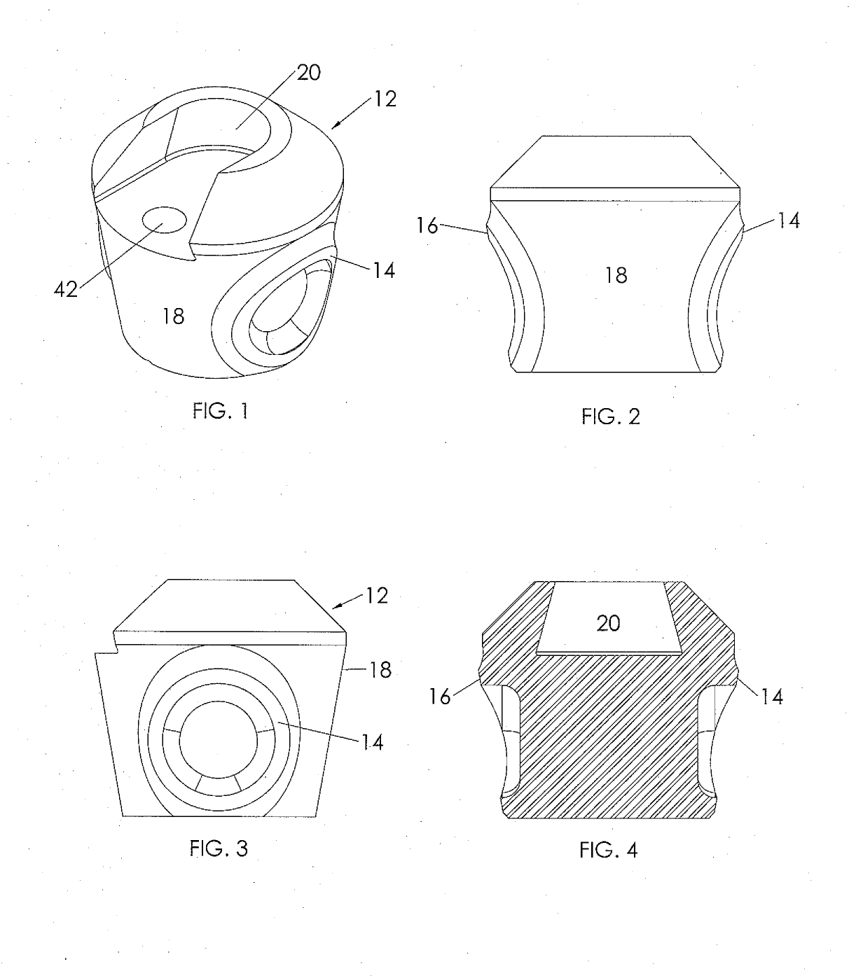

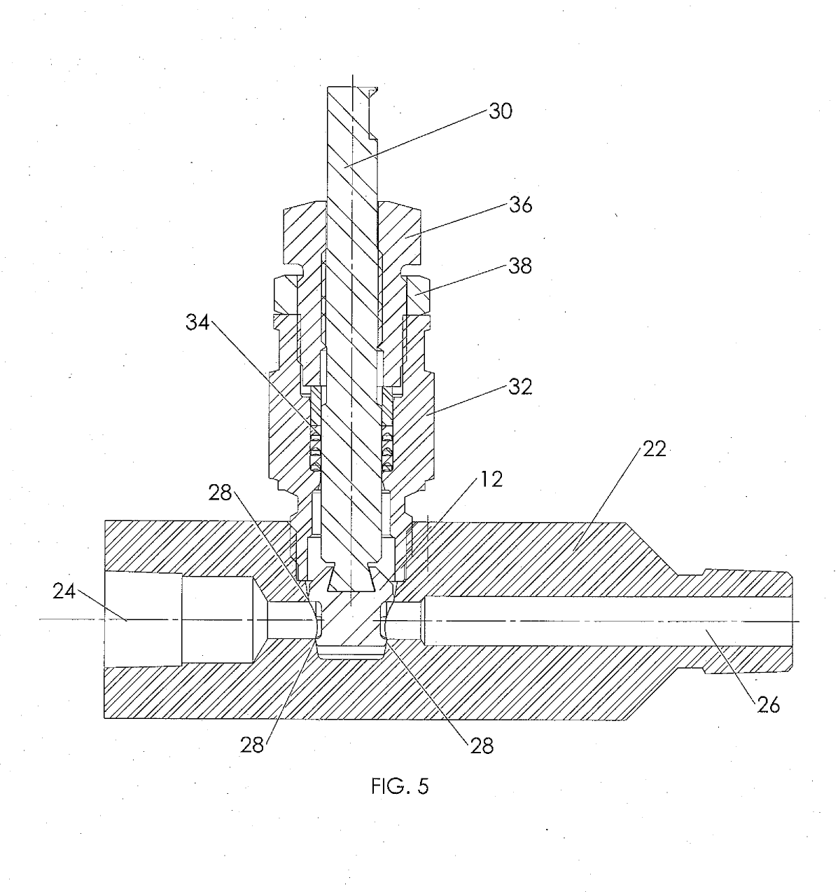

FIGS. 1-4 depict a suitable metal cone 12 having circumferentially opposing seating faces 14, 16 each raised from (radially outward of) the otherwise conical exterior surface 18 of the cone. In this embodiment, the seating surfaces extend outward from the generally cone shaped exterior surface of the cone 12. A dove-tailed shaped pocket 20 is provided at the upper end of the cone and is configured to receive the lower end of the valve stem, allowing for axial movement of the cone with the stem, while the stem rotates relative a nonrotating cone.

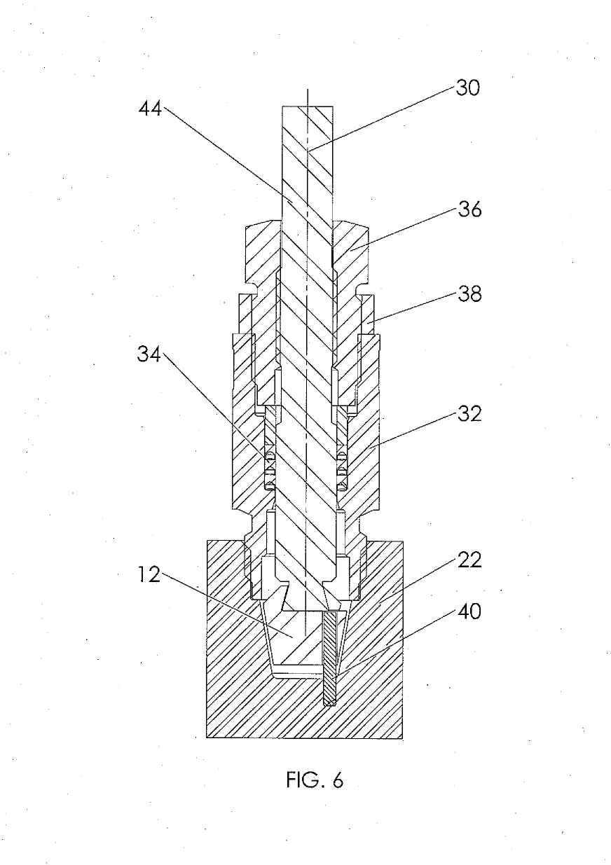

FIGS. 5 and 6 illustrate the cross section of a valve including valve body 22 having an inlet 24 and an outlet 26. The seat sealing engagement with the cone 12 may be provided directly on the valve body 22, as shown by the sealing surfaces 28 depicted in FIG. 5. The cone may reliably seal with a seat which is formed on and is integral with the valve body. Valve stem 30 is thus both axially and rotationally moveable relative to the valve body 22 to open and close the valve, and the stem may be driven by a hand operated mechanism or powered drive. Bonnet 32 is threaded to the valve body 26, and packing 34 is sealed between the stem and the bonnet by gland nut 36. Retaining nut 38 prevents unthreading of the gland nut 36 relative to the bonnet 32. FIG. 6 is another cross sectional view and shows rotation of cone 12 being prohibited by pin 40, which is positioned within a suitable cavity 42 as shown in FIG. 1 and engages a receiving cavity in the body 22, thereby limiting movement of the cone 12 relative to the body 22 to movement along the centerline 44 of the valve stem 30.

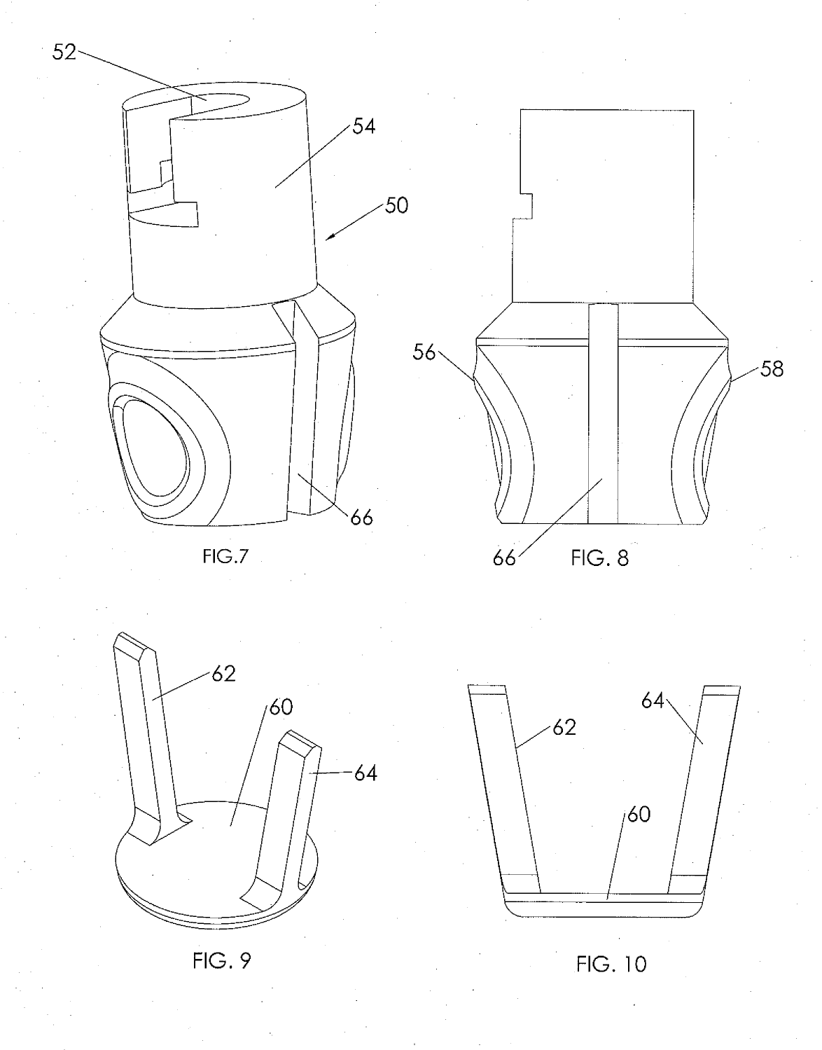

FIGS. 7 and 8 disclose an alternative embodiment of a cone 50 with cavity 52 in the upper end 54 of the cone, with the cavity receiving the lower end of the stem and allowing the cone to move axially with the stem but not rotate during rotation of the stem. Circumferentially spaced seating surfaces 56, 58 on the cone are as previously provided. In order to prevent axial movement of the cone, a base plate 60 with two upwardly and outwardly extending legs 62, 64 as shown in FIG. 9 are provided, each for fitting within a respective slot 66 in the cone and within a suitable mating slot in the valve body. The legs 62, 64, thus prohibit rotation of the cone 50 since the circumferentially opposing legs 62, 64 engage both the slots 66 in the cone and mating slots in the valve body. The advantage of the embodiments shown in FIGS. 6-9 is that greater force stability and strength are provided for limiting the cone to axial movement.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A cone plug valve, comprising:
a valve body having a fluid inlet, a fluid outlet, and a through passageway connecting the fluid inlet and the fluid outlet;
a valve stem having a stem axis and axially movable relative to the valve body during rotation of the valve stem;
a cone supported on the valve stem and having a generally cone shaped exterior surface, the cone rotatably separate from the valve stem and axially movable in response to axial movement of the valve stem;
a seat fixably positioned within the valve body for sealing engagement with the cone; and
the cone including a sealing surface extending outward from the cone shaped exterior surface for sealing with the seat to close off flow through the through passageway.

2. The cone plug valve as defined in claim 1, further comprising:
an alignment pin allowing the cone to move axially with respect to the seat while prohibiting the rotation of the cone with respect to the seat.

3. The cone plug valve as defined in claim 1, further comprising:
a pair of circumferentially spaced legs each connecting the cone and the valve body to move the cone axially with respect to the seat while prohibiting the rotation of the cone with respect to the seat.

4. The cone plug valve as defined in claim 1, wherein the seating surface on the cone is generally perpendicular to the through passageway in the valve body.

5. The cone plug valve as defined in claim 1, wherein the cone is formed from metal.

6. A cone plug valve, comprising:
a valve body having a fluid inlet, a fluid outlet, and a through passageway connecting the fluid inlet and the fluid outlet;
a valve stem having a stem axis and axially movable relative to the valve body during rotation of the valve stem;
a cone supported on the valve stem and having a generally cone shaped exterior surface, the cone rotatably separate from the valve stem and axially movable in response to axial movement of the valve stem;
a seat fixably positioned within the valve body for sealing engagement with the cone;
the cone including a sealing surface extending outward from the cone shaped exterior surface for sealing with the seat to close off flow through the through passageway; and
an alignment member allowing the cone to move axially while prohibiting rotation of the cone with respect to the seat.

7. The cone plug valve as defined in claim 6, wherein the alignment member is an alignment pin for engaging both the cone and the valve body.

8. The cone plug valve as defined in claim 6, wherein the alignment member is a pair of circumferentially spaced legs each connecting the cone and the valve body to move the cone axially with respect to the seat while prohibiting the rotation of the cone with respect to the seat.

9. The cone plug valve as defined in claim 6, wherein the seat is formed on and is integral with the valve body.

10. The cone plug valve as defined in claim 6, wherein the seating surface on the cone is generally perpendicular to the through passageway in the valve body.

11. A method of closing a cone plug valve, comprising:
providing a valve body having a fluid inlet, a fluid outlet, and a through passageway connecting the fluid inlet and the fluid outlet;
providing a valve stem having a stem axis and axially movable relative to the valve body during rotation of the valve stem;
supporting a cone on the valve stem and having a generally cone shaped exterior surface, the cone rotatably separate from the valve stem and axially movable in response to axial movement of the valve stem;
supporting a cone on the valve stem and having a generally cone shaped exterior surface, the cone rotatably separate from the valve stem and axially movable in response to axial movement of the valve stem;
positioning a seat within the valve body for sealing engagement with the cone; and
providing a sealing surface on the cone extending outward from the cone shaped exterior surface for sealing with the seat to close off flow through the through passageway.

12. The method as defined in claim 11, further comprising:
providing an alignment member to allow the cone to move axially with respect to the seat while prohibiting the rotation of the cone with respect to the seat.

13. The method as defined in claim 11, further comprising:
providing a pair of circumferentially spaced legs each connecting the cone and the valve body to move the cone axially with respect to the seat while prohibiting rotation of the cone with respect to the seat.

14. The method as defined in claim 11, wherein the seating surface on the cone is generally perpendicular to the through passageway in the valve body.

15. The method as defined in claim 11, wherein the cone is formed from metal.
